(19) United States
(12) Patent Application Publication
(10) Pub. No.: US 2007/0122775 A1
(43) Pub. Date: May 31, 2007

(54) Instruction method for learning of mental arithmetic

(76) Inventor: Chun-Chao Tseng, Taichung City (TW)

Correspondence Address: BIRCH STEWART KOLASCH & BIRCH, PO BOX 747, FALLS CHURCH, VA, 22040-0747, US

(21) Appl. No.: 11/270,570

(22) Filed: Nov. 10, 2005

(51) Int. Cl. G09B 19/02; G09B 23/02

(52) U.S. Cl. 434/188

(57) ABSTRACT

An instruction method for learning of mental arithmetic includes finger training, instruction instrument training and abstract training that are proceeded orderly and gradually in stages. The finger training mainly focuses on movements of ten fingers of user's two hands to form different gestures to match a calculation table to interpret the essentials of numeric decomposition and combination in calculations, and to practice finger exercises related to the calculations. The instruction instrument training aims to form graphics of numerals on a paper card to enable users to move and position the fingers on the paper card according to the numerals of different digits to do exercises of multi-digit calculations. The abstract training is executed after the user becomes skillful of the instruction instrument training to enable users to form naturally images of the paper card and finger movements and positions in the brain.

### FIELD OF THE INVENTION

The present invention relates to an instruction method for learning of mental arithmetic and particularly to an instruction method that gradually trains learning of mental arithmetic in three stages to perform calculations of addition, subtraction, multiplication and division by using ears, brain, hands, eyes and mouth simultaneously and through concurrent operations of left hand and right hand.

### BACKGROUND OF THE INVENTION

Calculation with abacus is a method of doing calculations through an abacus as a tool. To do multi-digit calculations correctly and rapidly that involve addition, subtraction, multiplication, division and evolutions of a root, users have to be skillful in using the abacus and familiar of special techniques that include selected rules and rhymed formula. Operating the abacus skillfully not only can rapidly derive the correct answer, but also can stimulate the brain cells. By mapping the pattern, format and bead movements of the abacus in the brain, and through the processes of perception, images and memorization, the brain can proceed with an intellectual activity to accomplish calculation. This is generally called mental arithmetic by calculation with the abacus.

Dr. Roger W. Sperry won Nobel Prize for Physiology or Medicine in 1981 for his study of functional specialization in the cerebral hemispheres. It reveals a new concept on human brain and provides a new scientific foundation for developing human intelligence. That theory mainly divides human brain into a left half semi-sphere and a right half semi-sphere. The left half semi-sphere (left brain) mainly takes cares the functions of reasoning, thinking, and judging such as speaking, writing, and calculation. The right half semi-sphere (right brain) mainly takes cares the functions of perception such as description, imitation, imagination or sentiment such as musical capability. Dr. Sperry's theory further claims that “The imagination power of the right brain is almost a million times of the left brain”. And the function of the left brain can be substituted by the computer and thousand of business machines. But the right brain cannot be substituted by any business machines. It has to be nurtured, exercised and developed by people.

Development of human intelligence is closely related to exercises and movements of fingers. Operation of abacus involves fast and delicate movements of fingers. Hence many contemporary educational experts think that mental arithmetic based on abacus is an advanced stage of calculation with the abacus.

Mental arithmetic or calculation is a combination of synthesized thinking and action. It is a concurrent process that demands instantaneous counting, virtualized imaging and simulated calculation. The whole process can stimulate thinking, memory, attention and spatial imagination of human brain to accomplish the mission of calculation. Hence the process of mental arithmetic needs coordinated activities of the left brain and right brain. In other words, mental arithmetic is a powerful tool to develop the intelligence. It is more helpful in the intelligence development of users than other brainpower development and training methods.

The conventional instruction method of mental arithmetic mainly focuses on training of bead movement of the abacus. Through endless and repetitive operations, the image of abacus is naturally mapped in the brain to help performing abstract mental calculation based on calculation with the abacus. However, in the operation of the abacus, a user generally holds the abacus with the left hand and moves the beads with the right hand to stimulate the left brain. It is a mechanical training and operation, and does not provide much help in the stimulation of the right brain. Users have to spend a great deal of time to become skillful without using the abacus, and to perform abstract mental calculation in the brain through a natural reflection.

### SUMMARY OF THE INVENTION

Therefore the primary object of the present invention is to solve the aforesaid disadvantages occurred to the fundamental learning stage. The present invention aims to provide an improved instruction method for learning of mental arithmetic that relies rapid operations of two hands, and especially focuses more operations of the left hand to stimulate the right brain, thereby to enhance user's image memory so that the user can rapidly master the mental arithmetic in a natural manner through synthesized thinking and actions.

Another object of the invention is to stimulate the brain cells through a great deal of finger activities during the learning process so that user's brain cells can react faster and become more intelligent.

The instruction method according to the invention includes finger training, instruction instrument training and abstract training that progress orderly and gradually in three stages. The finger training mainly aims to perform calculation through ten fingers of both hands. Through different hand gestures, with the right hand representing the unit digit, and the left hand representing the tenth digit, extending of the right thumb representing numeral 5, each of the rest four fingers representing numeral 1, clasping fist without extending fingers representing numeral 0, and combinations of the fingers of both hands representing numbers from 0 to 99. Meanwhile, a calculation table is incorporated to interpret the essentials of decomposition and combination in calculations, and the relationship between finger operations and the calculation essentials.

In the instruction instrument training, a paper card is used as an instruction instrument. On the paper card, there are line segments depicted by graphics. By learning the number of different digit locations and moving and positioning of the fingers on the paper card, exercises for multi-digit calculation can be performed. Through movements of the fingers on the paper card and the finger training previously discussed, and the essential of decomposition and combination of calculations, the final calculation result can be obtained.

After the user has completed the training of the instruction instrument, the pattern of the paper acrd appears naturally in the brain of the user. By mapping the image of finger movements and positions, the user can practice the abstract mental calculation.

The instruction method of the invention discloses a technique that uses fingers to represent different numbers and performs numeric calculation through finger alterations of both hands to enhance user's learning interest. Through an orderly and gradual approach, the user can understand the concept of mental arithmetic and abstract theory. And the user is guided to perform abstract calculation in the brain in a concrete and practical fashion to master the mental arithmetic. Aside from enhancing the capability of mathematical calculation, the finger movements of both hands during learning also can stimulate the brain to enhance user's brainpower. Thus it can establish a firm foundation for future development.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flowchart of the instruction method of the present invention.

FIGS. 2A and 2B are schematic views showing the relationship between hand gestures and numerals.

FIG. 3 is a calculation table for combination and decomposition of 10 according to the invention.

FIG. 4 is a calculation table for combination and decomposition of 5 according to the invention.

FIG. 5 is a calculation table for combination of “5+9 to 5+6”, and decomposition of “14−9 to 14−6” according to the invention.

FIG. 6 is a schematic view of the paper card of the invention.

FIGS. 7A through 7D are schematic views for fingers and the paper card in matching conditions.

FIG. 8 is a schematic view of the invention showing the paper card used in a calculation of addition.

### DETAILED DESCRIPTION OF THE PREFERRED EMBODIMENTS

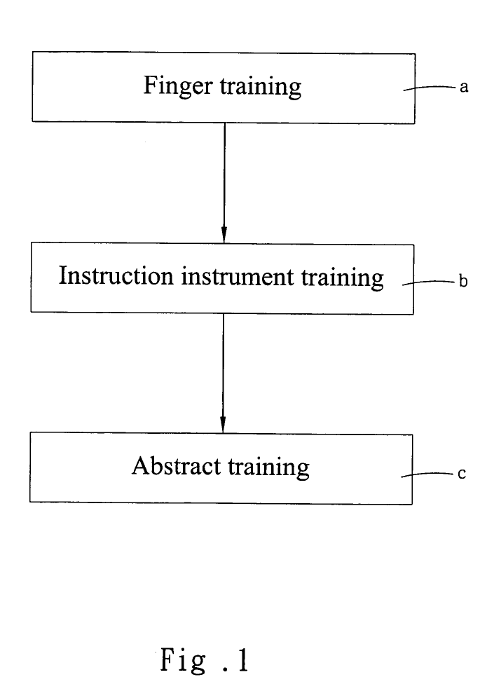

Please referring to FIG. 1, the instruction method according to the invention includes three stages: (a) finger training, (b) instruction instrument training, and (c) abstract training. They are executed orderly and gradually to train the capability of mental arithmetic for users.

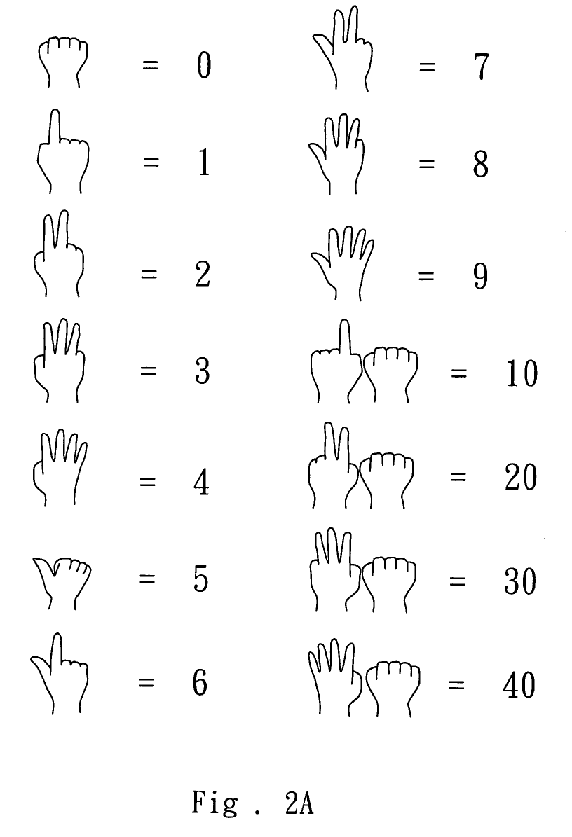

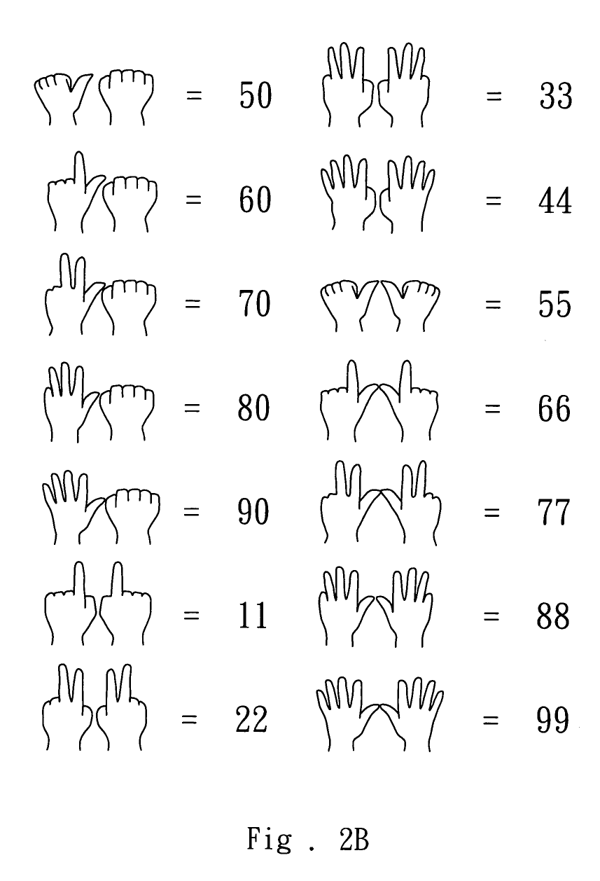

(a) Finger training: Ten fingers of user's both hands (left and right hands) move in various gestures to represent numerals from 0 to 99 (as shown in FIGS. 2A and 2B). The right hand represents the unit digit, while the left hand represents the tenth digit. The thumb represents 5, and each of other fingers represents 1. As shown in the drawings, the extending thumb represents 5, the extending first finger represents 1, the extending first and second fingers represent 2, the extending first, second and third fingers represent 3, the extending first, second, third and fourth fingers represent 4, the grasping fist without any finger extending represents 0. Hence the right hand can represent the numerals of the unit digit from 0 to 9. The left hand can represent numerals of the tenth digit from 0 to 90. And the combinations of both hands can represent numerals from 0 to 99.

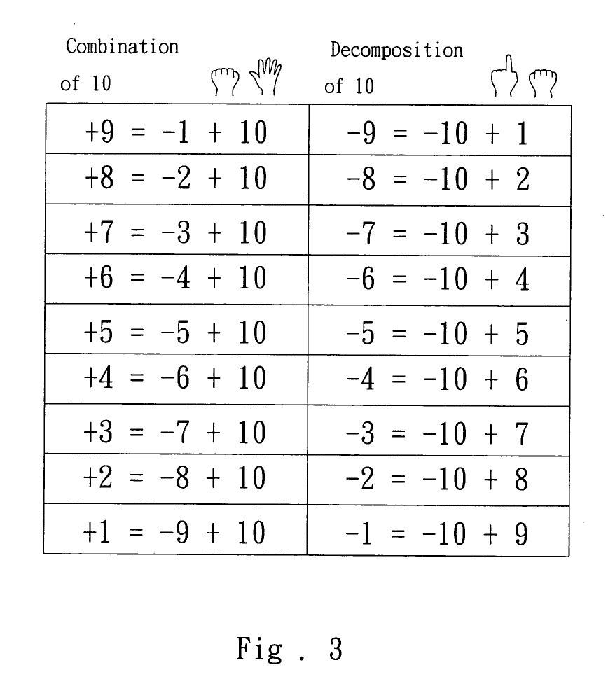

In addition, six fundamental calculation tables are derived by matching the combination and decomposition relationship of addition and subtraction calculations through ten finger movements (referring to FIGS. 3, 4 and 5) to facilitate user exercises. The calculation tables represent various calculation conditions and alteration of hand gestures. FIG. 3 indicates the combinations of 10. By addition 1 through 9, the finger gestures of the left and right hands change. For instance, with the left hand gesture starting at 0 and the right hand gesture at 9, when 9 is added, the right hand gesture subtracts 1 while the left hand gesture adds 10. When 8 is added, the right hand gesture subtracts 2 while the left hand gesture adds 10, and so forth. When 2 is added, the right hand gesture subtracts 8 while the left hand gesture adds 10. When 1 is added, the right hand gesture subtracts 9 while the left hand gesture adds 10. In short, to practice the numbers that include 9, a number of 9, 8 . . . 2 and 1 represented by a hand gesture altering condition is added to the numbers.

On the decomposition of 10 that represents subtracting 1 to 9, finger gestures of both hands are changed. As shown in the drawings, the left hand gesture starts at 10, while the right hand gesture starts at 0. To subtract 9, the left hand gesture subtracts 10 while the right hand gesture adds 1. To subtract 8, the left hand gesture subtracts 10 while the right hand gesture adds 2, and so forth. To subtract 2, the left hand gesture subtracts 10 while the right hand gesture adds 8. To subtract 1, the left hand gesture subtracts 10 while the right hand gesture adds 9. In short, to practice numerals that contain 10, a number of 9, 8 . . . 2 and 1 represented by a hand gesture altering condition is subtracted from the numbers.

Referring to FIG. 4, the combination of 5 indicates the timing of extending the right thumb for adding 1 to 4, and the alterations of the rest four fingers. As shown in the drawing, the right hand gesture indicates 4 initially. To add 4, the right thumb is extended while the rest fingers subtract 1. To add 3, the right thumb is extended while the rest fingers subtract 2. To add 2, the right thumb is extended while the rest fingers subtract 3. To add 1, the right thumb is extended while the rest fingers subtract 4. In short, to practice numerals that contain 4, a number of 4, 3, 2 and 1 represented by a hand gesture altering condition is added to the numbers.

The decomposition of 5 represents the timing of retracting the right thumb when 1 to 4 is subtracted, and alterations of the rest four fingers. As shown in the drawings, the right hand gesture starts at 5. To subtract 4, the right hand adds 1 and the thumb is retracted to subtract 5. To subtract 3, the right hand adds 2 and the thumb is retracted to subtract 5. To subtract 2, the right hand is extended to add 2 and the thumb is retracted to subtract 5. To subtract 1, the right hand adds 4 and the thumb is retracted to subtract 5. In short, to practice numerals that contain 5, a number of 4, 3, 2 and 1 represented by a hand gesture altering condition is subtracted from the numbers.

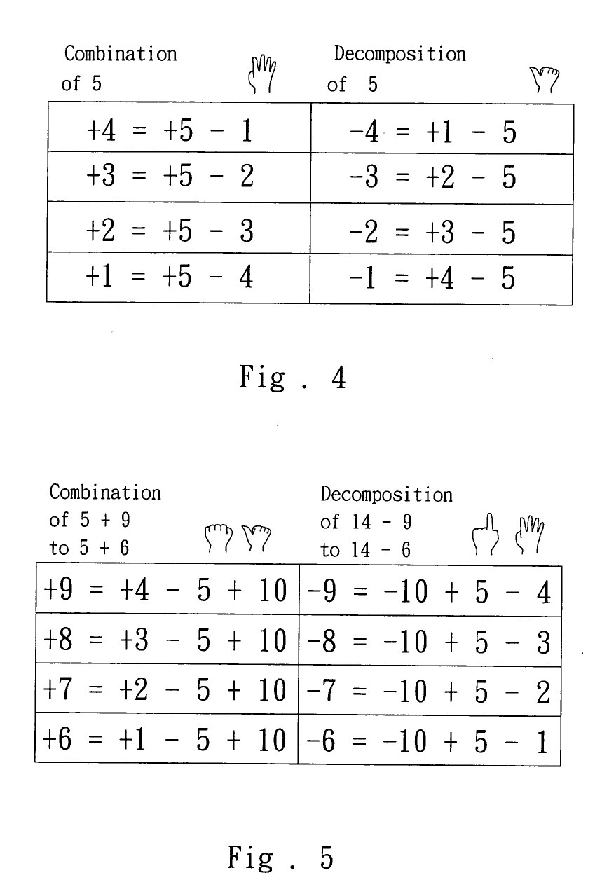

In the instructions of mental arithmetic, the maximum number of the unit digit that represents the numeral 1 is four, while only one represents the numeral 5. On the tenth digit, the maximum number that represents the numeral 10 is four, while only one represents the numeral 50, and so forth. Referring to FIG. 5, the combinations of “5+9 to 5+6” represent the combinations of numeral 5 adding numerals 9, 8, 7 and 6. The combinations can be interpreted as follow: As 5+9=5+4+5, and +5=−5+10, hence 5+9=5+4−5+10; namely, when there is a numeral 5 (extending of the right thumb), the process of adding 9 (+9) is first adding +4 (extending the fingers of the right hand that represent 4), then adding 5 (by first subtracting the thumb (−5), then extending the first finger of the left hand (+10)); finally, the left hand gesture shows 10 and the right hand gesture shows 4 to indicate that the answer of 5 plus 9 is 14. Applying the same principle, 5+6=+5+1+5, and +5=−5+10, therefore 5+6=5+1−5+10. Namely, when there is a numeral of 5 (extending the right thumb), the process of adding 6 (+6) is first to add +1 (extending the first finger of the right hand), and +5 means first to retract the right thumb (−5) and extend the first finger of the left hand (+10); finally the left hand gesture shows 10 while the right hand gesture shows 1 to indicate 11 as the answer of 5 plus 6.

The decomposition of “14−9 to 14−6” represents decomposition relationships of subtracting numeral 9, 8, 7 and 6 from numeral 14. The process is as follow: As −9=−10+5−4, hence 14−9=14−10+5−4. Namely the first finger of the left hand is extended, while four fingers of the right hand are extended except the right thumb to represent 14. To subtract 9 (−9), first, subtract 5 (withdraws the first finger of the left hand (−10), extends the right thumb (+5)); then subtract 4 (withdraw four fingers of the right hand except the right thumb); finally, right thumb remains in the extended condition, and the answer is 5 to represent 14 subtracting 9. Applying the same principle, as −6=−10+5−1, hence 14−6=14−10+5−1. Namely, the first finger of the left hand is extended, while the four fingers of the right hand excepted the right thumb are extended to indicate total 14. To subtract 6 (−6), first, subtract 5 (withdraw the first finger of the left hand (−10), then extend the right thumb (+5)); then subtract 1 (withdraw the fourth finger of the right hand); finally, the thumb and three fingers of the right hand remain in the extended condition to indicate the answer of 8 for subtracting 6 from 14.

By practicing moving of the ten fingers of both hands to perform addition and subtraction calculations that involve the tenth digit (left hand) and unit digit (right hand), the foundation of carry forward and backward in mental arithmetic can be established in user's mind. Moreover, as both hands are actively moved to do calculation at this stage, a substantial stimulation occurs to the brain cells and the activity frequency of the brain neurology increases. As a result, the development of brainpower is enhanced.

According to psychology and physiology, brain cells can be stimulated by active movements of fingers. The brain cells become more vigorous as the stimulation intensified. Hence the finger training process at this stage can stimulate the brain to balance and agitate the two semi-spheres. This can enhance user's intelligence.

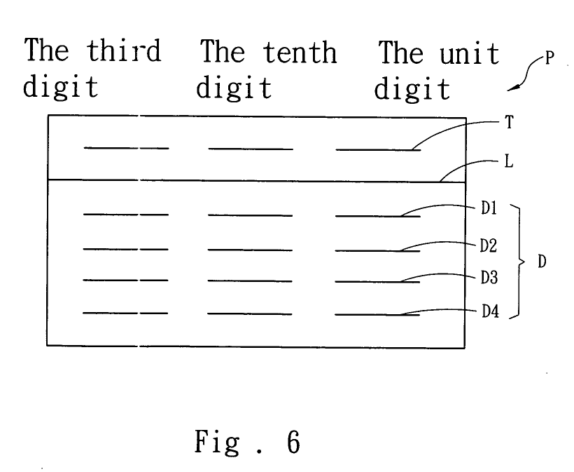

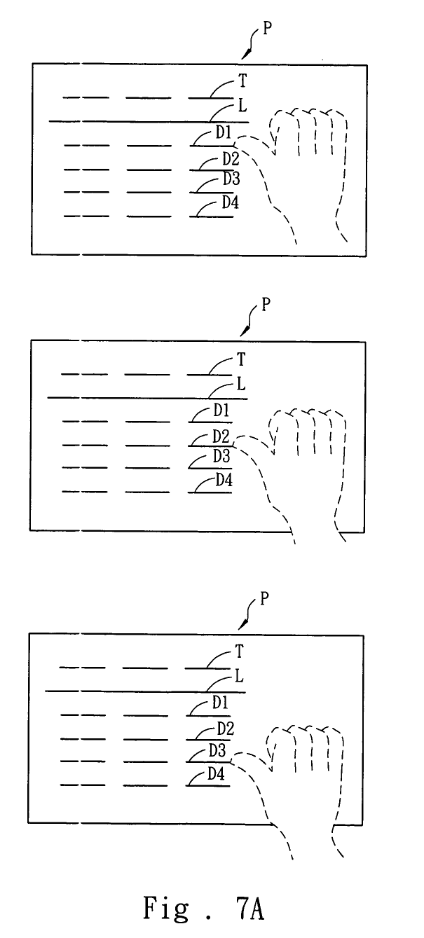

(b) Instruction instrument training: referring to FIG. 6, a paper card P is provided. The paper card P is divided into an upper portion and a lower portion by a long straight line L. A plurality of line segments are drawn on the paper card P to represent the first, second, third digital number and the like (three digital numbers are shown in FIG. 6. Of course, the digit number can be altered as desired). Each column of line segments has an upper line segment T above the straight line L to represent a numeral 5 of that digit. There are four lower line segments D below the straight line L, namely a first lower line segment D1, a second lower line segment D2, a third lower line segment D3 and a fourth line segment D4, spaced from the straight line L in this order to represent respectively numerals 1, 2, 3 and 4. In other words, on the column of the unit digit, the upper line segment T represents numeral 5, while the first lower line segment D1 represents numeral 1, the second lower line segment D2 represents numeral 2, the third lower line segment D3 represents numeral 3, and the fourth lower line segment D4 represents numeral 4. On the column of the tenth digit, the upper line segment T represents numeral 50, while the first lower line segment D1 represents numeral 10, the second lower line segment D2 represents numeral 20, the third lower line segment D3 represents numeral 30, and the fourth lower line segment D4 represents numeral 40, and so forth.

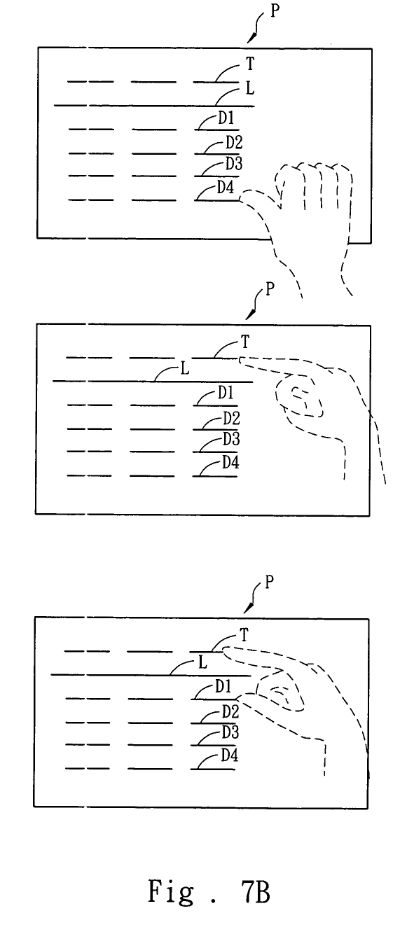

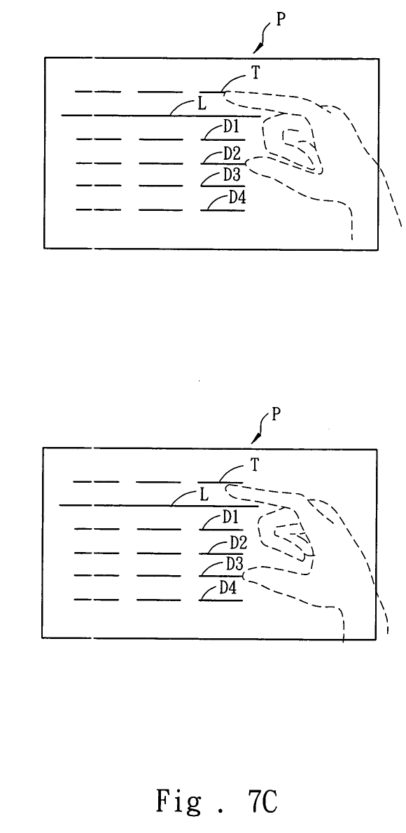

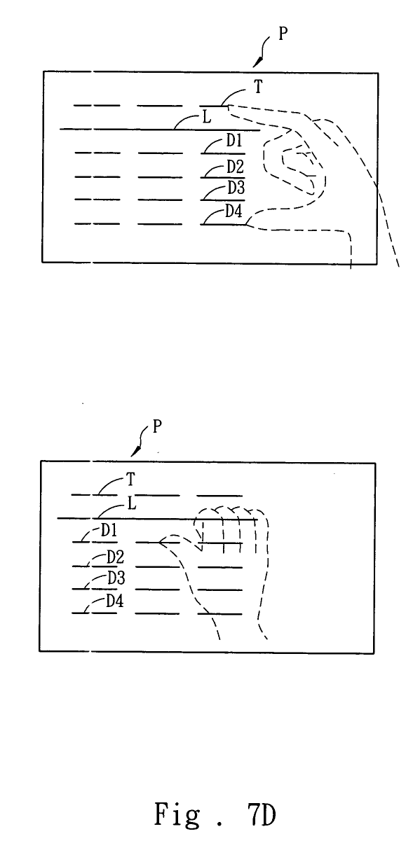

Refer to FIGS. 7A through 7D for fingers and the paper card in matching conditions. This stage aims to practice positioning and movement of user's thumb and first finger of the right hand on the paper card P. To indicate numeral 1, the right thumb is positioned on the first lower line segment D1 (unit digit number); to indicate numeral 2, the right thumb is positioned on the second lower line segment D2; to indicate numeral 3, the right thumb is positioned on the third lower line segment D3; to indicate numeral 4, the right thumb is positioned on the fourth lower line segment D4; to indicate numeral 5, the right first finger is positioned on the upper line segment T; to indicate numeral 6, the right first finger is positioned on the upper line segment T and the right thumb is positioned on the first lower line segment D1; to indicate numeral 7, the right first finger is positioned on the upper line segment T and the right thumb is positioned on the second lower line segment D2; to indicate numeral 8, the right first finger is positioned on the upper line segment T and the right thumb is positioned on the third lower line segment D3; to indicate numeral 9, the right first finger is positioned on the upper line segment T and the right thumb is positioned on the fourth lower line segment D4; and to indicate numeral 10, the right thumb is positioned on the first lower line segment D1 of the tenth digit. Based on this principle, the right thumb and first finger can be moved and positioned on the paper card P to indicate the maximum and minimum numbers. Incorporated with the number decomposition and combination calculation method learned in the finger training at the previous stage, a correct calculation result can be obtained.

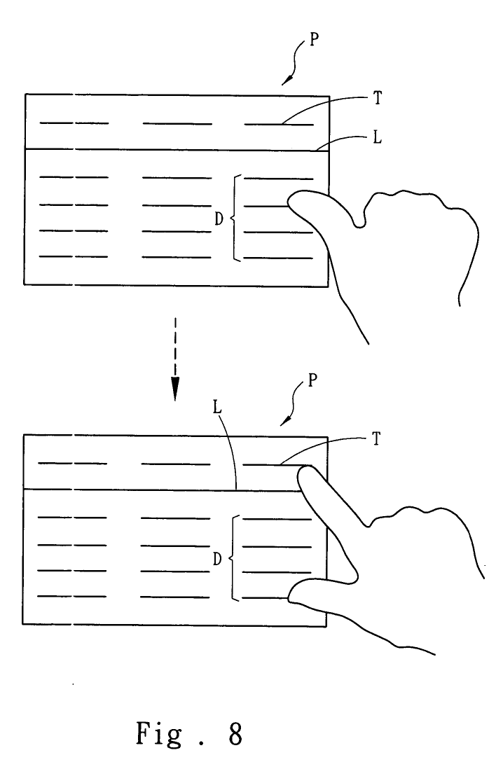

Refer to FIG. 8 for using of the instruction instrument in calculation. The calculation of adding 2 and 7 to become 9 is used as an example. First, move the right thumb to the second lower line segment D2 of the unit digit to represent 2; then move the right first finger to the upper line segment T, and move the right thumb downwards to the fourth lower line segment D4. The numbers represented by the right thumb and first finger are the answer, namely, the upper line segment T represents 5, and the fourth lower line segment D4 represents 4, and the answer represented by the thumb and first finger is 9. The same principle can be applied to perform calculations of addition, subtraction, multiplication and division with the aid of the paper card P.

(c) Abstract training: after having used the instruction instrument for training for a period of time and the user becomes skillful, the image of the pattern of the paper card P and the moving positions of the fingers can appear naturally in user's brain. Then an imaginative simulation exercise can be performed. The thinking speed is much faster than the actual movement of the fingers on the paper card P. And numeric calculation can be done naturally to get correct answer rapidly.

In summary, the instruction method of the invention adopts an orderly and gradual approach to guide users to perform mental calculation in the imaginative arena of the right brain. Aside from enhancing mathematical calculation capability, the movements of the left fingers during the learning process can stimulate the brain to boost the brainpower of the right brain. Hence a firm foundation can be established for future development. The first stage of the invention mainly focuses on movements of ten fingers. The second stage focuses on operation of the fingers on the paper card P. The third stage focuses on abstract calculation. It is an orderly and gradual approach to enable users to understand the concept and abstract theory of the mental arithmetic. Through concrete and semi-concrete means, the users can be guided to become skillful of the abstract thinking, and learn and master mental arithmetic.

Moreover, the first stage of the instruction method of the invention relies on movements of ten fingers to perform calculations. The ten fingers of both hands represent different numbers and move vigorously. The left hand is heavily used. Hence the right brain is highly stimulated. This can enhance the development of the brain power of the right brain. It also helps users to enhance memory, creativity, thinking, organization and imagination. As mathematics and mental calculation are mainly the function of the right brain, the correct instruction method for learning mental arithmetic can stimulate the right brain to make mastering mathematics more effective and easier.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An instruction method for learning of mental arithmetic, comprising finger training, instruction instrument training and abstract training that are proceeded orderly and gradually in stages, wherein:
the finger training mainly focuses on movements of ten fingers of user's two hands, the hands forming varying gestures that include the right hand to represent a unit digit and the left hand to represent a tenth digit, an extending thumb to represent numeral 5, each of the rest four fingers to present 1, a clasping fist without extending fingers to represent 0, and the fingers of the two hands to represent 0 to 99 in varying combinations, a calculation table being provided to match the movements the fingers to interpret decomposition and combination of numerals in calculations to facilitate learning of calculation relationship between the movements of the fingers and the numerals;
the instruction instrument training includes an instrument made of a paper card which has line segments to form graphics for numerals represented by the fingers, by moving user's fingers on the paper card and incorporating the decomposition and combination of numerals in calculations at to the previous stage, exercises of multi-digit calculations being executable through the numerals of different digits and moving and positioning locations of the fingers on the paper card;
the abstract training is performed after the user becomes skillful of the instruction instrument training to generate naturally a pattern of the paper card and images of the finger movements and positions in user's brain to proceed imaginative simulation exercises.

2. The instruction method of claim 1, wherein the paper card contains an abacus graphic pattern which includes an elongated straight line to divide the paper card into an upper portion and a lower portion;
a plurality of line segments represents each digit, and the line segments includes an upper line segment located above the straight line to represent numeral 5; and
four lower line segments below the straight line include in this order a first lower line segment to represent numeral 1, a second lower line segment to represent numeral 2, a third lower line segment to represent numeral 3, and a fourth lower line segment to represent numeral 4.
